(19) United States
(12) Patent Application Publication
(10) Pub. No.: US 2003/0112207 A1
(43) Pub. Date: Jun. 19, 2003

(54) Single-scan driver for OLED display

(76) Inventors: Chang Oon Kim, Seoul (KR); Keunmyung Lee, Palo Alto, CA (US)

Correspondence Address: Chung K. Ko, Suite 236, 3003 N. First St., San Jose, CA, 95134, US

(21) Appl. No.: 10/232,575

(22) Filed: Aug. 30, 2002

Related U.S. Application Data
(60) Provisional application No. 60/342,020, filed on Dec. 18, 2001.

(51) Int. Cl. G09G 3/32

(52) U.S. Cl. 345/82

(57) ABSTRACT

A single scan driver for an organic light emitting diode (OLED) display is disclosed, that can reduce the required power consumption. By connecting together both ends of each column line so that a single driver circuit can drive both ends of each column line together, the column line resistance is reduced, resulting a significant reduction in power consumption.

### RELATED APPLICATION

This application claims the benefit of co-pending U.S. Provisional Application Ser. No. 60/342,020, filed Dec. 18, 2001, entitled “Single-Scan Driver for OLED Display.”

### BACKGROUND OF THE INVENTION

1. Technical Field

This invention in general relates to semiconductor circuits and flat panel display modules. More specifically, this invention relates to circuits for driving columns of organic light emitting diode (OLED) displays.

2. Description of the Related Art

An organic light emitting diode (OLED) display is made up of rows and column electrodes for selectively activating the OLED device at each intersection. FIG. 1 shows a conventional single scan driving scheme where an OLED panel 10 is driven by a row driver 11 that drives row electrodes an a column driver 12 that drives column electrodes. The row electrodes are scanned in sequence to refresh the display image.

As the OLED display becomes larger with an increased number of row electrodes, the resistance of the column electrodes increases, which, in turn, increases the power dissipation along the columns.

There is a dual scan scheme where a flat panel display is divided into two parts, an upper panel and a lower panel, and there are two column drivers, each of which is responsible for driving each half panel. The dual scan scheme helps reduce the power consumption by reducing the resistance of column electrodes by 50%. However, the dual scan scheme has the problem of non-uniformity of brightness across the boundary between the upper and lower panels.

Therefore, there is a need for a new single scan scheme that can drive an OLED display with less power consumption without dividing the panel.

### SUMMARY OF THE INVENTION

It is an object of the present invention to provide a single scan driving scheme for an OLED display with reduced power consumption.

Another object of the present invention is to provide a single scan driving scheme that can drive an OLED display with a reduced voltage.

The foregoing and other objects are accomplished by providing a single scan driving scheme using a column driver whose outputs connect to both sides of the OLED panel so as to reduce the column line load resistance of the panel. The power dissipation is reduced as a result as well as the required column driving voltage.

### BRIEF DESCRIPTION OF THE DRAWINGS

FIG. 1 shows a conventional single scan driving scheme for driving an OLED display.

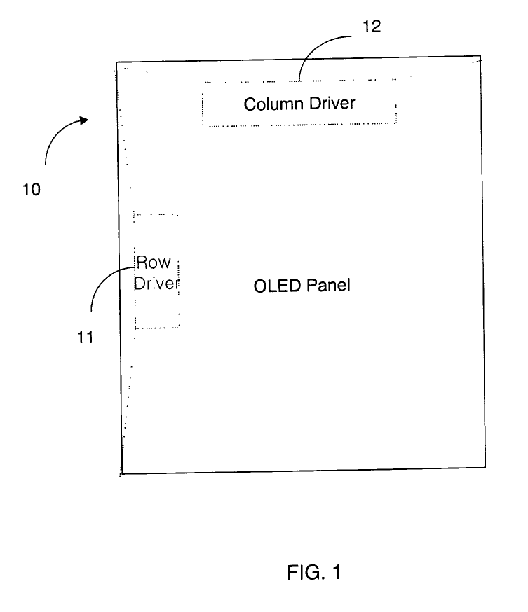

FIG. 2 shows a new single scan driving scheme of the present invention using one column driver whose outputs connect both sides of the OLED panel.

FIG. 3 shows an equivalent circuit of an OLED panel.

FIGS. 4A and 4B show two arrangements of the output pads of the column driver.

FIG. 5 shows a single chip solution integrating both the row driver and column driver as well as a controller for controlling the row and column drivers.

### DETAILED DESCRIPTION OF THE INVENTION

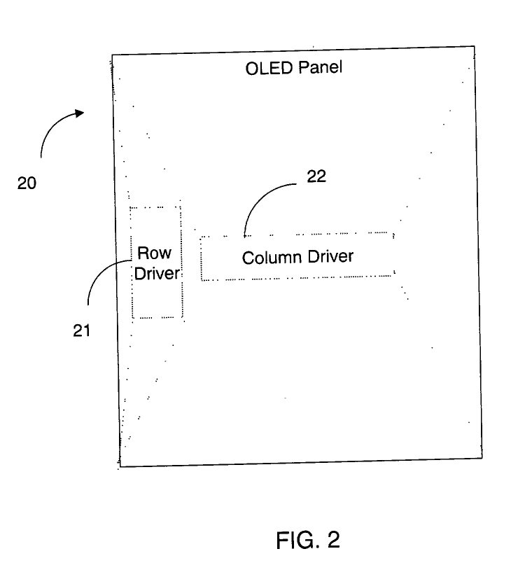

FIG. 2 shows the present invention where an OLED panel 20 is driven by a row driver 21 that drives row electrodes and a column driver 22, preferably located at the center, that drives both ends of the column electrodes. Because each column line is driven at both sides, the column line resistance is reduced as much as ¼ of that driven by one side only.

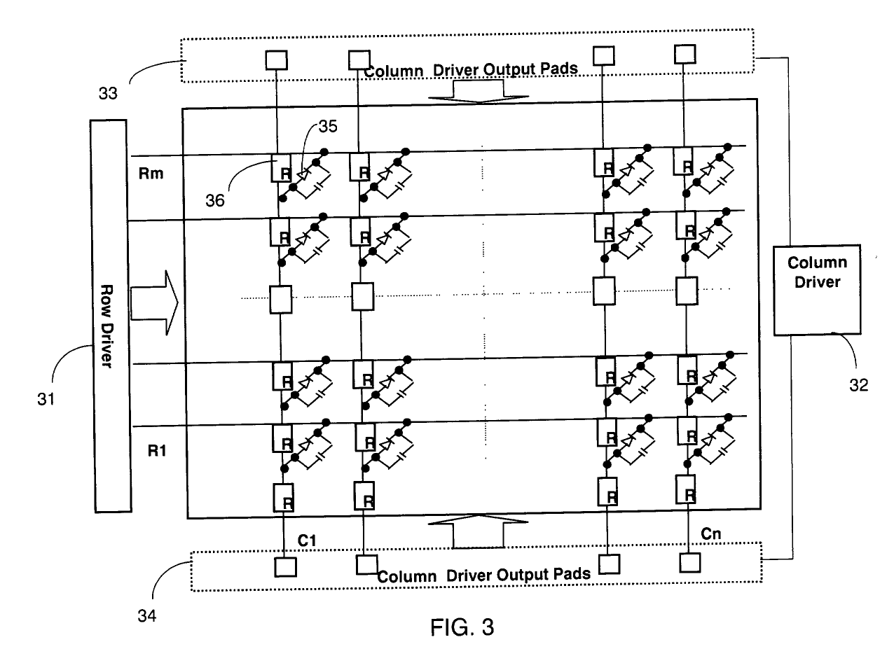

FIG. 3 shows an equivalent circuit of an OLED panel consisting of m number or row electrodes and n number of column electrodes with a row driver 31 for driving the row electrodes and a column driver 32 whose output pads 34 and 34 connected at both top and bottom sides respectively for driving the column electrodes. At each intersection of the row and column electrodes are a diode 35 representing an organic LED and R 36 representing the resistance for a row-pitch segment of each column.

Let Cx represents the number of columns, lout the output driver current. The voltage for driving the OLED display, Voled, where each column line is driven from a single end, is expressed as follows:

Voled=(Iout*Cx*Ron)+Vd+Vt+(Rload*Iout)

where Ron is the output resistance of a selected row; Vd is the diode-on voltage of OLED, which is around 2.5 to 3.5 volts; Vt is the voltage across an output transistor. which ranges 2-4 volts; and Rload is the resistance of the column line.

The present invention reduces the column line resistance Rload as much as up to ¼ of the value by connecting together both ends of each column line so as that each end of the column line is at an equal potential driven by a single driving circuit. Then, the voltage for driving the OLED display Voled where each column line is driven from both ends is expressed as follows:

Voled=(Iout*Cx*Ron)+Vd+Vt+(0.25Rload*Iout)

The max power dissipation in the column driver, Pc, is expressed as:

$$\begin{matrix}Pc = ( lout * Cx ) * ( Voled - ( Iout * Ron * Cx ) - 0.25 Rload * \\ lout - Vd ) \\ = ( Iout * Cx ) * Vt\end{matrix}$$

The max power dissipation in the row driver, Pr, is expressed as:

Pr=(Iout*Cx)*(Iout*Cx)*Ron

The total max power dissipation P in both row and column drivers is expressed as follows:

P=(Iout*Cx)*Voled

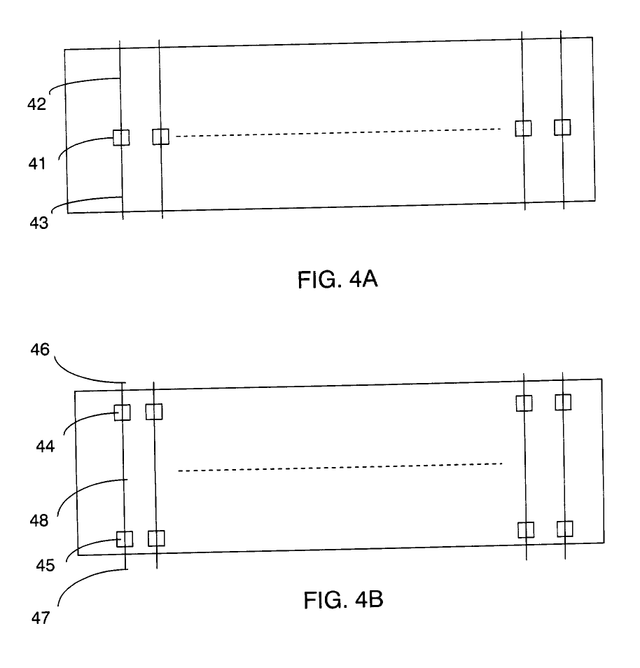

FIG. 4A shows one arrangement of the output pads of the column driver. The output pads such as 41 are located at the center, from which output leads 42 and 43 extend to upper and lower sides. FIG. 4B shows another arrangement of output pads where output pads such as 44 and 45 are located at the upper and lower boundaries, each having its own output lead such as 46 and 47 extending to the respective side. Each corresponding pair of pads such as 44 and 45 are made to short each other by 48.

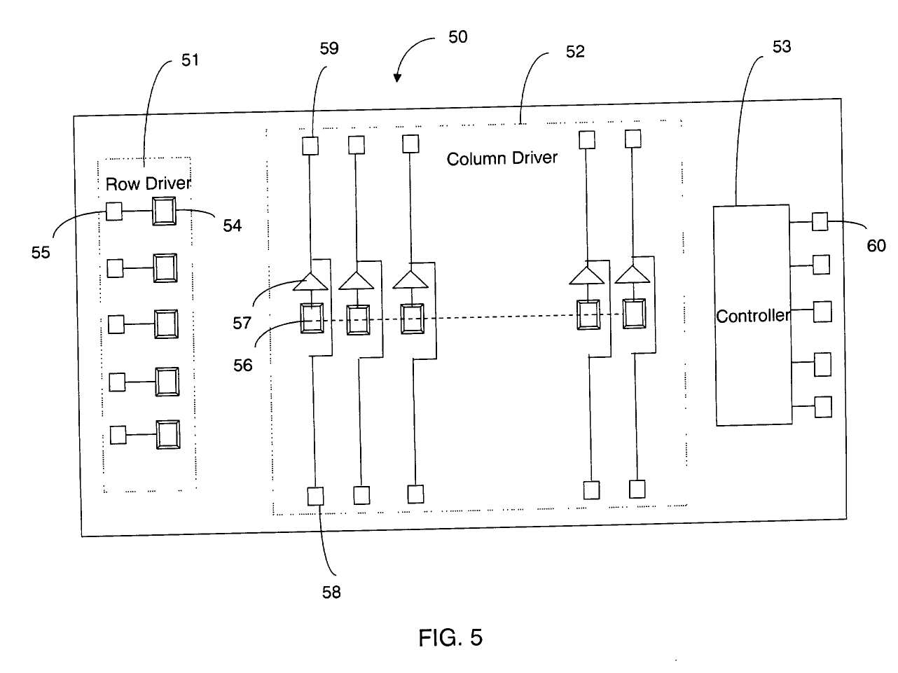

FIG. 5 shows a single chip solution as an alternative embodiment, where a single chip 50 includes both a row driver 51 having a driver circuit such as 54 and output pads such as 55, and a column driver 52 having a driver circuit such as 56, a buffer such as 57, and output pads such as 58 and 59 for driving a single-scan OLED display. It may further include a controller 53 with input pads such as 60 for providing control information to the row and column drivers. The single chip 50 may be designed to further include memory cells for storing graphics data and power circuits (not shown in the figure).

While the invention has been described with reference to preferred embodiments, it is not intended to be limited to those embodiments. It will be appreciated by those of ordinary skilled in the art that many modifications can be made to the structure and form of the described embodiments without departing from the spirit and scope of this invention.

What is claimed is:

1. A driver for driving columns of a single-scan LED panel consisting of row and column electrodes, comprising:
a common driver circuitry;
a first set of output leads from the driver circuitry extending to the top end of the panel to connect to the column electrodes;
a second set of output leads from the driver circuitry extending to the bottom end of the panel to connect to the column electrodes;
wherein both ends of each column electrode are driven at a same potential by a single driving circuit whereby the resistance along each column electrode is reduced.

2. The driver of claim 1, wherein the LED panel is an OLED panel.

3. The driver of claim 1, wherein the driving circuit is located substantially at the center in the back side of the panel

4. A single-scan LED panel, comprising:
row electrodes;
column electrodes, each having a top end and a bottom end;
a first set of terminals connecting to the top ends of the column electrodes;
a second set of terminals connecting to the bottom ends of the column electrodes;
the first set of terminals connected to output leads extending from a column driver;
the second set of terminals are connected to output leads extending from the same column driver;
wherein both ends of each column electrode are driven at a same potential by a single driving circuit whereby the resistance along each column electrode is reduced.

5. The LED panel of claim 4, wherein the LED panel is an OLED panel.

6. The LED panel of claim 4, wherein the driving circuit is located substantially at the center in the back side of the panel

7. A method of driving columns of a single-scan LED panel consisting of row and column electrodes, comprising:
providing a common driver circuitry;
extending a first set of output leads from the driver circuitry to the top end of the panel to connect to the column electrodes;
extending a second set of output leads from the driver circuitry to the bottom end of the panel to connect to the column electrodes;
wherein both ends of each column electrode are driven at a same potential by a single driving circuit whereby the resistance along each column electrode is reduced.

8. The method of claim 7, wherein the LED panel is an OLED panel.

9. The method of claim 7, wherein the driving circuit is located substantially at the center in the back side of the panel
